(19) United States
(12) Patent Application Publication
(10) Pub. No.: US 2020/0009527 A1
(43) Pub. Date: Jan. 9, 2020

(54) Composition and Process for Capturing Carbon Dioxide

(71) Applicant: PRECISION COMBUSTION, INC., North Haven, CT (US)

(72) Inventors: Jeffrey Weissman, Guilford, CT (US); Codruta Loebick, North Haven, CT (US)

(73) Assignee: PRECISION COMBUSTION, INC.

(21) Appl. No.: 16/572,724

(22) Filed: Sep. 17, 2019

Related U.S. Application Data
(62) Division of application No. 14/929,723, filed on Nov. 2, 2015.
(60) Provisional application No. 62/093,016, filed on Dec. 17, 2014.

(51) Int. Cl. B01J 20/04; B01J 20/30; B01D 53/62

(52) U.S. Cl. CPC B01J 20/041; B01J 20/3078; B01J 20/3021; B01D 2251/602; B01D 2251/404; B01D 2258/0283; B01D 53/62

(57) ABSTRACT

A solid sorbent composition including as chemical components: calcium oxide, calcium aluminate, and a mixed metal oxide characterized by a perovskite crystalline structure. The solid sorbent finds utility in capturing carbon dioxide from any gaseous stream containing carbon dioxide, such as emissions streams produced in combustion processes or streams derived from closed environments including airplanes, spaceships, and submarines. A reversible carbon dioxide looping process is disclosed involving (a) contacting a carbon dioxide-containing gaseous stream with the solid sorbent composition in a carbonator to produce a solid mixture containing calcium carbonate and a gaseous stream reduced in carbon dioxide concentration; and (b) heating the solid mixture containing calcium carbonate in a calcinator (decarbonator) to regenerate the solid sorbent composition and to produce a gaseous stream enriched in carbon dioxide.

### CROSS-REFERENCE TO RELATED APPLICATION

This application is a divisional of U.S. patent application Ser. No. 14/929,723, filed Nov. 2, 2015, which claims benefit of U.S. Provisional Application No. 62/093,016, filed Dec. 17, 2014, both applications of which are incorporated in their entirety herein by reference.

### FIELD OF THE INVENTION

In a first aspect, this invention pertains to a solid composition of matter capable of capturing carbon dioxide from a carbon dioxide-containing gaseous stream. In a second aspect, this invention pertains to a method of making the solid composition of matter disclosed herein. In a third aspect, this invention pertains to a process of capturing carbon dioxide from a carbon dioxide-containing gaseous stream, by employing the solid composition of this invention. In a related aspect, this invention pertains to a reversible process employing the aforementioned solid composition to capture carbon dioxide from a carbon dioxide-containing gaseous stream with generation of calcium carbonate, and thereafter regenerating the solid composition and releasing a stream enriched in carbon dioxide for storage or industrial use.

### BACKGROUND OF THE INVENTION

Power generation combustion systems, such as coal-fired power plants, are responsible for about one-third of all anthropogenic carbon dioxide emissions. Capturing carbon dioxide from power generation combustion systems presents a technically challenging problem, not least of which is an intensive energy demand. Existing power plants can be retrofit with a post-combustion process to capture carbon dioxide although such processes are currently less than optimal. One current process for capturing carbon dioxide involves contacting post-combustion flue gas emissions with a chemical solvent, such as an amine, for example monoethanolamine (MEA), which solubilizes carbon dioxide. Suitable chemical solvents tend to be expensive and suffer from several other shortcomings. Flue gases, for example, contain various sulfur oxides that can react irreversibly with amine solvents to produce non-reclaimable and corrosive salts. Additionaly, hot flue gases cause amine degradation that decreases absorbent efficiency. Environmental factors associated with amine usage are also a significant consideration. Regenerating the amine solvent results in a large energy penalty, which renders the process less economically attractive. To be specific, regeneration of amine solvents using steam, generated through the power plant's main gas turbine, can use more than 4 gigajoules energy per ton of carbon dioxide (>4 GJ/ton CO₂).

An alternative method for capturing carbon dioxide from flue gas emissions involves use of a calcium looping cycle, which is based on high-temperature reversible carbonation of calcium oxide sorbent with carbon dioxide to form calcium carbonate, as seen in Equation 1:

CaO+CO₂CaCO₃ Eqn. 1

On an industrial scale carbon dioxide capture by calcium looping utilizes a fluidized bed technology, a mature engineering method allowing for easy processing of large volumes of flue gas. Typically, the power plant is retrofit with two fluidized bed reactors with the sorbent continuously circulated between them. One reactor comprises a carbonator wherein calcium oxide sorbent is carbonated with a carbon dioxide-containing flue gas at a temperature ranging from about 600° C. to 750° C. to produce calcium carbonate, resulting in a flue gas having a reduced concentration of carbon dioxide. The other reactor comprises a calcinator or decarbonator wherein the calcium carbonate is calcined at a temperature ranging from about 850° C. to 950° C. to regenerate the calcium oxide sorbent with production of an essentially pure stream of carbon dioxide. The calcinator is typically operated on a feed of oxygen and fuel, such as coal, to ensure that a substantially enriched stream of carbon dioxide exits the calcinator. The recovered carbon dioxide can be sequestered in an underground repository or bottled for industrial use.

The fluidized bed calcium looping technology described hereinabove provides several advantages. First, the process operates at high temperatures; therefore, a substantial portion of energy can be recuperated from hot gas and hot solid streams exiting the system to drive a steam cycle, which beneficially minimizes parasitic energy consumption. Second, the fluidized bed technology is well developed and capable of processing large volumes of flue gas. Third, calcium oxide is a cheaper and more environmentally benign sorbent as compared to amine-based solvents. Fourth, spent calcium carbonate is usable in cement industries. Fifth, calcium oxide can be used for capturing sulfur oxides; thus an efficient calcium looping process may also eliminate a need for a desulfurization unit.

On the other hand, the calcium looping technology suffers from a significant disadvantage; namely, calcium oxide quickly degrades between carbonation and decarbonation cycles. For regular limestone (CaO), conversion to carbonate decreases from 0.60 gram carbon dioxide per gram calcium oxide (0.60 g CO₂/g CaO) in a first cycle to a residual 0.17 g CO₂/g CaO in a tenth cycle, as disclosed by C. Dean, et al., Chemical Engineering Research and Design, Vol. 89, 2011, p. 836ff. The degradation is mainly a result of two factors: (a) surface area loss through sintering at the high calcination temperature, and (b) attrition of sorbent through continual circulation between the two fluidized bed reactors, the latter leading to sorbent elutriation from the system. As a consequence, deactivation of calcium oxide necessitates introducing a large make-up flow of fresh sorbent (or calcium carbonate) into the calcinator, resulting in an increasing cost and energy penalty, as the fresh sorbent must be heated to the required calcination temperature. (See J. Abanades et al., Environmental Science & Technology, Vol. 41, 2007, p. 5523ff.)

The above discussion is focused on capturing carbon dioxide from industrial emissons where carbon dioxide is present in a substantial concentration. Many applications exist, however, where it would be beneficial to remove carbon dioxide from gaseous environments containing a comparatively lower concentration of carbon dioxide. One such application involves looping a purified emissions stream, that is, after removal of most but not all of the carbon dioxide, through a secondary carbon dioxide removal process to purify the stream to even lower concentrations of carbon dioxide. Another applicaton involves removing carbon dioxide from closed systems containing a low concentration of carbon dioxide, such as from airplane cabins, space ships, submarines and other underwater closed systems, and from building ventilation systems and other sealed terrestrial environments. In yet another application, it may be desirable to remove carbon dioxide from atmospheric air, so as to employ the captured carbon dioxide in a downstream chemical process. It should be appreciated that as the concentration of carbon dioxide decreases, the driving force to react carbon dioxide with calcium oxide also decreases, thereby rendering the removal of CO₂ less efficient.

The prior art as found, for example, in M. Kierzkowska, R. Paccinni, and C. R. Muller, “CaO-Based CO₂ Sorbents: From Fundamentals to the Development of New, Highly Effective Materials,” Chem Sus Chem, Vol. 6, 2013, pp. 1130-1148, discloses a list of individual metal oxides that can be combined with calcium oxide for capturing carbon dioxide. Among the metal oxides disclosed are individually alumina (Al₂O₃), calcium aluminates Ca₉(Al₂O₆)₃ and Ca₁₂Al₁₄O₃₃, zirconia (ZrO₂), magnesia (MgO), and lanthanum oxide (La₂O₃).

The use of mayenite (Ca₁₂Al₁₄O₃₃) in combination with calcium oxide for carbon dioxide capture is also disclosed by R. Paccinni, C. R. Muller, J. F. Davidson, J. S. Dennis, and A. N. Hayhurst, in “Synthetic Ca-Based Solid Sorbents Suitable for Capturing CO₂ in a Fluidized Bed,” The Canadian Journal of Chemical Engineering, Vol. 86, 2008, pp. 356-366; and by Su. F. Wu and Ming Z. Jiang, in “Formation of a Ca₁₂Al₁₄O₃₃ Nanolayer and Its Effect on the Attrition Behavior of CO₂-Adsorbent Microspheres Composed of CaO Nanoparticles,” Ind. Eng. Chem. Res., Vol. 49, 2010, pp. 12269-12275.

The art would benefit from discovery of a new solid sorbent composition capable of capturing carbon dioxide with improved sorbent capacity, with long lifetime, and with little, if any, degradation over many carbonation-decarbonation cycles, as compared with known carbon dioxide sorbents. The composition would be more desirable if it exhibited high sorbent capacity for removing carbon dioxide from a gaseous stream containing a low concentration of carbon dioxide, namely, a stream containing less than 3 volume percent, and preferably, as low as 0.04 volume percent carbon dioxide. Such a composition would be even more desirable if it provided sufficient attrition resistance such that the composition could be employed commercially in a calcium looping fluidized bed reactor system.

### SUMMARY OF THE INVENTION

In a first aspect, this invention provides for a novel solid sorbent composition capable of capturing carbon dioxide, wherein the composition comprises calcium oxide, calcium aluminate, and a mixed metal oxide characterized by a perovskite crystalline structure.

In a second aspect, this invention provides for a novel process of capturing carbon dioxide from a carbon dioxide-containing gaseous stream. The process comprises contacting the gaseous stream comprising carbon dioxide with a solid sorbent composition comprising calcium oxide, calcium aluminate, and a mixed metal oxide characterized by a perovskite crystalline structure. The contacting of the gaseous stream with the solid sorbent composition is conducted under carbonation process conditions sufficient to produce a solid mixture comprising calcium carbonate.

In a third aspect, this invention provides for a novel reversible process of capturing and recovering carbon dioxide from a carbon dioxide-containing gaseous stream. This process comprises:
(a) in a carbonation reactor, contacting a gaseous stream comprising carbon dioxide with a solid sorbent composition comprising calcium oxide, calcium aluminate, and a mixed metal oxide characterized by a perovskite crystalline structure; the contacting occuring under carbonation process conditions sufficient to produce a solid mixture comprising calcium carbonate and a gaseous stream comprising a reduced concentration of carbon dioxide; and
(b) in a calcination reactor, heating the solid mixture comprising calcium carbonate under decarbonation process conditions sufficient to regenerate the solid sorbent composition comprising calcium oxide, calcium aluminate, and the mixed metal oxide having the perovskite crystalline structure, and under decarbonation process conditions sufficient to produce a gaseous stream enriched in carbon dioxide.

In a fourth aspect, this invention provides for a novel method of synthesizing a solid sorbent composition capable of reversibly capturing carbon dioxide from a carbon dioxide-containing gaseous stream. The synthesis method comprises:
(a) preparing a slurry comprising a liquid diluent, calcium oxide or a precursor thereof, aluminum oxide or a precursor thereof, and a mixed metal oxide characterized by a peroviskite crystalline structure or a precursor thereof;
(b) milling the slurry;
(c) drying the slurry to remove the liquid diluent; and
(d) calcining the dried slurry under calcination conditions sufficient to produce the solid sorbent comprising calcium oxide, calcium aluminate, and the mixed metal oxide characterized by the perovskite crystalline structure.

As compared with prior art compositions, the composition of this invention is capable of capturing an improved capacity of carbon dioxide from a carbon dioxide-containing gaseous stream, such as but not limited to an industrial flue gas. More specifically, the composition of this invention provides acceptable sorbent capacity with gaseous streams containing a wide range of carbon dioxide concentrations, from as low as 0.04 percent to 100 percent, by volume, while maintaining an acceptable calcium oxide conversion to calcium carbonate. It should be appreciated that the composition of this invention advantageously retains its sorbent capacity over multiple carbonation-decarbonation cycles at temperatures in excess of 900° C. As an added benefit, the composition of this invention can be employed in a fluidized bed technology for processing large volumes of flue gas or other carbon dioxide-containing gaseous streams applicable to an industrial scale.

It should be further appreciated that the solid sorbent composition of this invention advantageously tolerates certain flue gas contaminants that otherwise cause problems for prior art amine sorbents. In this regard, calcium oxide, a component of the composition of this invention, is known to be a useful sorbent for sulfur oxides present in flue gases. Moreover, whereas capturing carbon dioxide with an amine sorbent has a parasitic demand of about 12 percent energy efficiency; in contrast, the process of this invention utilizing the novel sorbent composition disclosed herein can be thermally integrated to produce steam, thereby lowering the parasitic demand to a penalty of less than 5 percent energy efficiency. Furthermore, the calcium oxide looping process of this invention offers a potential cost reduction of about 50 percent versus prior art calcium oxide looping technologies and about 70 percent versus prior art amine technologies.

### DRAWINGS

FIG. 1 illustrates a flow chart of a process of capturing carbon dioxide utilizing a fluidized bed carbonator and a fluidized bed calcinator (decarbonator). The process can be employed with the sorbent composition of this invention.

FIG. 2 illustrates an X-ray diffraction pattern (XRD) of an embodiment of an as-synthesized sorbent composition of this invention.

FIG. 3 presents a graph plotting percent of maximum CO₂ sorption capacity as a function of number of carbonation cycles for an embodiment of the solid sorbent composition and process of this invention. For comparative purposes the graph illustrates the maximum CO₂ sorption capacity as a function of carbonation cycles for a prior art calcium oxide sorbent.

FIG. 4 presents an XRD pattern of an embodiment of the solid sorbent composition of this invention after cycling through 15 carbonation and decarbonation cycles, ending on a decarbonation cycle.

FIG. 5 presents an XRD pattern of an embodiment of the solid sorbent composition of this invention after cycling through 42 carbonation and decarbonation cycles, ending on a carbonation cycle.

FIG. 6 presents a graph plotting CO₂ sorbent capacity as a function of number of carbonation cycles for an embodiment of the solid sorbent composition and process of this invention, as compared with several prior art sorbent samples.

### DETAILED DESCRIPTION OF THE INVENTION

We have discovered a novel solid sorbent composition comprising three components: calcium oxide, calcium aluminate, and a mixed metal oxide characterized by a perovskite crystalline structure. In one application, the novel sorbent composition finds utility in capturing carbon dioxide from a flue gas stream obtained from the combustion of coal or other carbon-bearing fuels. In this regard, the composition of this invention provides for reducing anthropogenic emissions of carbon dioxide, an unwanted greenhouse gas contributing to global warming. In another application, the composition of this invention is capable of removing carbon dioxide from gaseous environments containing a low concentration of carbon dioxide, namely, those having a CO₂ concentration as low as about 0.04 volume percent. One such application involves looping a purified emissions stream, after a first-pass removal of most but not all of the carbon dioxide, through the process of this invention for a second time, so as to purify the stream to even lower concentrations of carbon dioxide. Another applicaton involves removing carbon dioxide from the atmosphere of closed systems, such as from the atmosphere of airplane cabins, spaceships, submarines, building ventilation systems, and any other sealed environment. In yet another application, the composition finds utility in capturing carbon dioxide from atmospheric air for downstream use, for example, in chemical processes requiring carbon dioxide as a reactant or solvent. The novel sorbent composition further finds utility in releasing captured carbon dioxide on demand under calcination conditions, so as to produce a stream enriched in carbon dioxide, which can be permanently sequestered or bottled for industrial use.

In one embodiment, the solid sorbent composition comprises calcium oxide, calcium aluminate selected from crystalline structures of molecular formula Ca₉(Al₂O₆)₃ (nonacalcium tris(dialuminate)), CaAl₄O₇ (grossite), CaAl₂O₄ (dmitryivanovite), and Ca₁₂Al₁₄O₃₂Y (mayenite), wherein Y is selected from the group consisting of O²⁻, N²⁻, (OH⁻)₂, (F)₂, (Cl⁻)₂, (H₂O)₄(Cl⁻)₂, (H₂O)₄(F⁻)₂, and (e⁻)₂ where e⁻ represents a free electron, and mixtures thereof; and further comprises a mixed metal oxide characterized by a perovskite crystalline structure of formula ABX₃, wherein A is a divalent cation of Group IIA and B is a tetravalent cation of Group IVA; or alternatively, A is a trivalent cation selected from Group IIIA and the lanthanide rare earths, and B is a trivalent cation of Group IIIB; and X represents divalent oxide (O²⁻).

In a related embodiment, this invention provides for a process of capturing carbon dioxide from a carbon dioxide-containing gaseous stream. The process comprises contacting a gaseous stream comprising carbon dioxide with the solid sorbent composition of this invention, the contacting being conducted under carbonation process conditions sufficient to produce a solid mixture comprising calcium carbonate and a gaseous stream comprising a reduced concentratin of carbon dioxide. In the aforementioned process, the solid sorbent composition of this invention comprises calcium oxide, calcium aluminate selected from crystalline structures of molecular formula Ca₉(Al₂O₆)₃ (nonacalcium tri s(dialuminate)), CaAl₄O₇ (grossite), CaAl₂O₄ (dmitryivanovite), and Ca₁₂Al₁₄O₃₂Y (mayenite), wherein Y is selected from the group consisting of O²⁻, N²⁻, (OH⁻)₂, (F⁻)₂, (Cl⁻)₂,H₂O)₄(Cl⁻)₂, (H₂O)₄(F)₂, (H₂O)₄(Cl⁻)₂, (H₂O)₄(F⁻)₂, and (e⁻)₂ where e⁻ represents a free electron, and mixtures thereof; and further comprises a mixed metal oxide characterized by a perovskite crystalline structure of formula ABX₃, wherein A is a divalent cation of Group IIA and B is a tetravalent cation of Group IVA; or alternatively, A is a trivalent cation selected from Group IIIA and the lanthanide rare earths, and B is a trivalent cation of Group IIIB; and X represents divalent oxide.

In another related embodiment, this invention provides for a reversible process of capturing and recovering carbon dioxide from a carbon dioxide-containing gaseous stream. The process comprises:
(a) in a first fluidized bed, contacting a gaseous stream comprising carbon dioxide with a solid sorbent composition, the contacting occuring under carbonation process conditions sufficient to produce a solid mixture comprising calcium carbonate and a gaseous stream comprising a reduced concentration of carbon dioxide; wherein the solid sorbent composition comprises calcium oxide, calcium aluminate selected from crystalline structures of molecular formula Ca₉(Al₂O₆)₃ (nonacalcium tris(dialuminate)), CaAl₄O₇ (grossite), CaAl₂O₄ (dmitryivanovite), and Ca₁₂Al₁₄O₃₂Y (mayenite), wherein Y is selected from the group consisting of O²⁻, N²⁻, (OH⁻)₂, (F⁻)₂, (Cl⁻⁾₂, (H₂O)₄(Cl⁻)₂, (H₂O)₄(F⁻)₂, and (e⁻)₂ where e⁻ represents a free electron, and mixtures thereof; and further comprises a mixed metal oxide characterized by a perovskite crystalline structure of formula ABX₃, wherein A is a divalent cation of Group IIA and B is a tetravalent cation of Group IVA; or alternatively, A is a trivalent cation selected from Group IIIA and the lanthanide rare earths, and B is a trivalent cation of Group TIM; and X represents divalent oxide; and
(b) in a second fluidized bed, heating the solid mixture comprising calcium carbonate under decarbonation process conditions sufficient to regenerate the solid sorbent composition and sufficient to produce a gaseous stream enriched in carbon dioxide; the solid sorbent composition comprising calcium oxide, calcium aluminate selected from crystalline structures of molecular formula Ca₉(Al₂O₆)₃ (nonacalcium tris(dialuminate)), CaAl₄O₇ (grossite), CaAl₂O₄ (dmitryivanovite), and Ca₁₂Al₁₄O₃₂Y (mayenite), wherein Y is selected from the group consisting of O²⁻, N²⁻, (OH⁻)₂, (F⁻)₂, (Cl⁻)₂, (H₂O)₄(Cl⁻)₂, (H₂O)₄(F⁻)₂, and (e⁻)₂ where e⁻ represents a free electron, and mixtures thereof; and further comprising a mixed metal oxide characterized by a perovskite crystalline structure of formula ABX₃, wherein A is a divalent cation of Group IIA and B is a tetravalent cation of Group IVA; or alternatively, A is a trivalent cation selected from Group IIIA and the lanthanide rare earths, and B is a trivalent cation of Group TIM; and X represents divalent oxide.
   As used herein, the term “fluidized bed” embraces sorbent beds having a wide range of hydrodynamic lift, including but not limited to lifted beds, ebullated beds, and moving beds.

The solid sorbent composition of this invention requires calcium oxide. Commonly known as “quicklime”, calcium oxide is a white, alkaline, crystalline solid of molecular formula CaO and molecular weight 56.08 g/mol. It readily reacts with carbon dioxide (CO₂) at temperatures above 500° C., as illustrated in Eqn. 1 hereinabove, to form calcium carbonate (CaCO₃), otherwise known as “calcite” or sometimes “aragonite” or “vaterite”. Under calcination conditions, the carbonate is reversibly converted back to calcium oxide (CaO) with release of CO₂. Alternatively, each of the calcium oxide and calcium carbonate can be independently present as a compositionally equivalent amorphous (non-crystalline) phase rather than a crystalline phase. Likewise, a mixture of crystalline and non-crystalline phases can be present. The calcium oxide and calcium carbonate are not limited to the aforementioned phases; other crystalline and/or non-crystalline phases not specifically mentioned herein can be suitably employed. In addition, the calcium oxide can be present in the composition of this invention in a hydrated form, as hydrated calcium oxide of molecular formula Ca(OH)₂, known as “portlandite”. Additionally, mixtures of anhydrous calcium oxide (CaO) and hydrated calcium oxide (Ca(OH)₂) are suitably employed in the composition of this invention.

In its decarbonated form, the solid sorbent composition of this invention comprises greater than about 30 percent, and preferably, greater than about 50 percent calcium oxide (dried basis) by weight, based on the total weight of the composition. In its decarbonated form, the solid sorbent composition of this invention comprises less than about 90 percent, and preferably, less than about 80 percent calcium oxide (dried basis) by weight, based on the total weight of the composition.

Calcium aluminate is another required component of the solid sorbent composition of this invention. In one embodiment, the calcium aluminate is present in a mayenite crystalline structure having a molecular formula expressed as Ca₁₂Al₁₄O₃₂Y, wherein Y is selected from the group consisting of O²⁻, N²⁻, (OH⁻)₂, (F⁻)₂, (Cl⁻)₂, (H₂O)₄(Cl⁻)₂, (H₂O)₄(F⁻)₂, and (e⁻)₂ where e⁻ represents a free electron. In another embodiment, the calcium aluminate is present in a nonacalcium tris(dialuminate) crystalline structure having a molecular formula expressed as Ca₉(Al₂O₆)₃. Other crystalline calcium aluminates suitable for this invention include, without limitation, grossite represented by molecular formula CaAl₄O₇ and dmitryivanovite (krotite) represented by molecular formula CaAl₂O₄. Other crystalline phases of calcium aluminate not specifically mentioned herein may also be suitably employed. The identification of crystalline calcium aluminates can be made by any conventional analytical technique including X-ray diffraction (XRD), electron diffraction, and Raman spectroscopy, as applicable. Generally, XRD is preferred. A suitable reference for XRD patterns of the aforementioned crystalline materials is found, for example, on-line at http://RRUFF.info.

Alternatively, the calcium aluminate is present as a compositionally equivalent amorphous (non-crystalline) phase, rather than a crystalline phase. Likewise, a mixture of crystalline and non-crystalline phases of calcium aluminate can be present. The calcium aluminate is not limited to the aforementioned phases; other crystalline and/or non-crystalline phases not specifically mentioned herein can be suitably employed.

The amounts of the various forms of calcium aluminate can vary as a function of specific process conditions during synthesis of the composition, as a function of specific carbonation and decarbonation conditions, and as a function of time of use on stream. It is possible to synthesize the composition with the calcium aluminate essentially exclusively in the Ca₉(Al₂O₆)₃ crystalline form. Mayenite may begin to form under calcination or decarbonation conditions. Mayenite may form and then disappear with time on stream. Other crystalline and/or non-crystalline phases of calcium aluminate, including mixtures thereof, may be present in the freshly synthesized composition or any of the used compositions.

In its decarbonated form, the solid sorbent composition of this invention comprises greater than about 5 percent, and preferably, greater than about 15 percent calcium aluminate by weight, based on the total weight of the composition. In its decarbonated form, the composition of this invention comprises less than about 50 percent, and preferably, less than about 40 percent calcium aluminate by weight, based on the total weight of the composition.

The mixed metal oxide characterized by the perovskite structure is the third required component of the solid sorbent composition of this invention. As the component of lowest weight percentage, the mixed metal oxide may be considered an additive, or depending on how low its concentration, a dopant. In its decarbonated form the composition of this invention comprises greater than about 2 percent, preferably, greater than about 5 percent mixed metal oxide of perovskite structure by weight, based on the total weight of the composition. In its decarbonated form the composition of this invention comprises less than about 20 percent, preferably, less than about 15 percent mixed metal oxide by weight, based on the total weight of the composition.

The perovskite crystalline structure is represented by the general formula ABX₃, wherein A and B are cations of different sizes, A being larger than B; and X is an anion that bonds to both cations. An ideal cubic symmetry has the B cation in 6-fold coordination surrounded by an octahedron of X anions. Ideally, the A cation has a 12-fold cuboctahedral coordination. The X anions typically occupy face centers. Distortions and buckling as a result of differing cation sizes can lower the symmetry, for example, to orthorhombic, tetragonal, or trigonal.

In one preferred embodiment of this invention, A is a divalent cation selected from Group IIA of the Periodic Table, which is paired with a tetravalent cation B ion selected from Group IVA. “X” represents divalent oxide (O²⁻). The Group IIA cations include divalent metal ions selected from beryllium, magnesium, calcium, strontium, barium, and mixtures thereof. Preferably, the Group IIA cation is strontium or barium or a mixture thereof. The Group IVA cations include the tetravalent ions selected from titanium and zirconium, and mixtures thereof, preferably, titanium. In another preferred embodiment, A is a trivalent cation selected from Group IIIA or the lanthanide rare earths, which is paired with a trivalent B cation selected from Group IIIB. Again, X represents divalent oxide (O²⁻). The Group IIIA ions include trivalent scandium and yttrium, and mixtures thereof the lanthanide rare earth ions include the trivalent ions of lanthanum, gadolinium, and ytterbium, and mixtures thereof. The Group IIIB cations include trivalent aluminum. Among more preferred perovskites are the following embodiments: lanthanum aluminate (LaAlO₃), barium titanate (BaTiO₃), strontium titanate (SrTiO₃), and mixtures thereof.

The perovskite crystalline phase may be present in conjunction with one or more non-crystalline (amorphous or glassy) phases of a compositionally equivalent mixed metal oxide.

One method of synthesizing the solid sorbent composition of this invention involves preparing a slurry comprising a liquid diluent, calcium oxide or a precursor thereof, calcium aluminate or a precursor thereof, and the mixed metal oxide characterized by the perovskite crystalline structure or a precursor thereof. Thereafter, the slurry is milled for a period of time. Milling involves mixing, tumbling, rolling, or otherwise agitating the slurry in the presence of a milling media that facilitates formation of small particles and intimate mixing of all slurry components. After milling, the slurry is dried to remove the liquid diluent and then heated under calcination conditions sufficient to produce the solid sorbent composition of this invention.

In another synthesis method, the liquid diluent can be eliminated from the aforementioned preparation; and a solid mixture can be prepared comprising calcium oxide or a precursor thereof, calcium aluminate or a precursor thereof, and the mixed metal oxide having the perovskite crystalline structure or a precursor thereof. The solid mixture can be milled for a time in the absence of liquid diluent and then heated under calcination conditions sufficient to produce the solid sorbent composition of this invention.

Calcium oxide in hydrated (Ca(OH)₂) and non-hydrated forms (CaO) can be used in the sythesis mixture. Calcium carbonate, calcium nitrate, or a mixture thereof can be suitably employed, as non-limiting examples of the precursor to calcium oxide. In one embodiment, the precursor to calcium aluminate comprises a mixture of calcium oxide (anhydrous or hydrated) combined with alumina or a hydrated form of alumina. Other suitable precursors to the calcium aluminate include, without limitation, hydrotalcite of molecular formula CaAl₂(CO₃)₂(OH)₄.3H₂O and hydrocalumite of molecular formula Ca₄Al₂(OH)₁₂ (Cl, OH)₂.4H₂O or formula Ca₄Al₂(OH)₁₂ (CO₃).4H₂O. Mixtures of any of the aforementioned materials can be employed as precursors to the calcium aluminate. Among the precursors to the mixed metal oxide having the perovskite crystalline structure, we find that the oxides, hydroxides, and salts of the relevant mixed metal components can be used. Among suitable salts are included, without limtation, the corresponding metal nitrates, metal sulfates, metal halides, and metal carboxylates, such as the metal acetates and metal oxylates. Preferably, the salt is a combination of mixed metal nitrates. Accordingly, in preparing the Group IIA mixed metal titanate, it is acceptable to use a precursor mixture comprising, for example, barium oxide, strontium oxide, barium nitrate, and/or strontium nitrate in combination with titania. In preparing the Group IIIA or lanthanide rare earth aluminate, it is acceptable to use a precursor mixture, for example, comprising lanthanum nitrate, yttrium nitrate, and/or scandium nitrate in combination with alumina or a hydrated form of alumina.

The relative quantities of compounds or precursors used in preparing the slurry are calculated based on weight percentages of calcium oxide, calcium aluminate, and mixed metal oxide of perovskite structure desired in the final sorbent composition. One skilled in the art knows how to calculate the slurry composition based upon the desired end product. For acceptable results, the slurry comprises from about 10 to about 50 percent solids, the balance being a liquid diluent capable of ready volatilization at a temperature between about 50° C. and 150° C. Acceptable diluents include water (preferably deionized), C₁-₄ alcohols, and mixtures of water and C₁₋₄ alcohols. Milling is accomplished in air, typically at room temperature and ambient pressure for at least 1 hour, preferably, from about 4 to about 24 hours. The milling process itself involves tumbling, rotating, or otherwise agitating the slurry in the presence of a milling media, which typically comprises a collection of ceramic particles in the form of beads, spheres, cylinders, or any other suitable shape. Milling provides intimate contact between the slurry components by reducing particle sizes and by increasing surface area available for carbon dioxide capture.

After milling, the slurry is separated from the milling material by any suitable method, for example, decanting, sieving, siphoning, or vacuuming; and then the recovered slurry is dried at a temperature sufficient to evaporate greater than about 70 percent, preferably, greater than about 90 percent of the liquid diluent. The drying can be conducted using conventional drying techniques, such as in a conventional oven, or by spray drying, or by spray atomization into a hot gas. Afterwards, the dried slurry is calcined at a temperature generally in excess of 800° C., and preferably greater than about 800° C. and less than about 1400° C., under an oxidizing atmosphere, such as air or molecular oxygen, for a time sufficient to convert the components or precursor compounds to the solid sorbent composition of this invention. Preferably, the dried slurry is calcined for at least 1 hour. If desired, the dried slurry can be fed to the fluidized bed calcinator and calcined therein.

The carbonation process of this invention is conducted in any suitable reactor, such as a fixed bed or fluidized bed reactor, provided that the reactor's materials of construction are operable under carbonation (adsorption) process conditions. The fluidized bed reactor is preferred, especially when a decarbonation step is to be employed to recover the solid sorbent. Generally, the carbon dioxide-containing gaseous stream is contacted with the bed containing the solid sorbent under carbonation process conditions sufficient to capture carbon dioxide per the forward reaction of Equation 1 hereinabove to produce calcium carbonate. The carbon dioxide-containing gaseous stream fed to the reactor generally comprises carbon dioxide in a concentration ranging from about 0.04 volume percent up to 100 volume percent. Such streams include air streams (0.04 vol.% CO₂) as well as emissions streams from combustion processes, such as flue gas streams emanating from coal power plants, wherein the carbon dioxide concentration typically ranges from about 15 to about 20 volume percent. Other streams accommodated by the carbonation process include atmospheric air, gas streams from air ventilation systems, gas streams from closed environments, such as airplanes, spaceships, submarines, and any other sealed enclosure.

Carbonation is typically conducted at a temperature greater than about 500° C., and preferably, greater than about 650° C. Carbonation is typically conducted at a temperature less than about 750° C., preferably, less than about 725° C. Since the carbonation reaction is an equilibrium process, as illustrated in Equation 1 hereinabove, for practical purposes the rate of carbonation is typically too slow below a termperature of about 500° C. Above about 750° C., the rate of decomposition of the carbonate begins to accelerate. The flow rate of the carbon dioxide-containing gaseous stream through the carbonator can vary as known to the person skilled in the art. The gaseous stream exiting from the carbonation process comprises a reduced concentration of carbon dioxide, as compared with the carbon dioxide-containing gaseous stream fed to the carbonator. Typically, from about 50 percent to about 95 percent of the carbon dioxide can be removed from the gas stream, depending upon the inlet stream CO₂ concentration, the flow rate of the inlet stream, the quantity of sorbent, and temperature, amongst other factors.

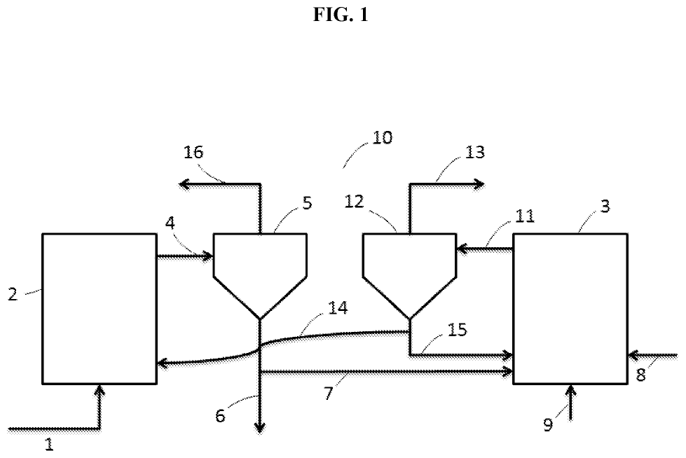

The carbonation reactor has been described hereinabove and in FIG. 1 as a single reactor; however, another embodiment would employ a plurality of carbonation reactors, including two, three, or more carbonation reactors, connected in series. In this embodiment, the reactors are connected via a conduit or flow path, such that the decarbonated gaseous stream exiting one reactor is fed into the next reactor. The purpose of such a design is to conduct the decarbonation in a series of reactors operating at decreasing temperatures, so as to push the equilibrium reaction (Eqn. 1) to increasing yields of calcium carbonate and thus a decreasing concentration of carbon dioxide in sequential decarbonated gaseous streams. As an example, a three-stage decarbonator can be envisioned with the first decarbonator operating at 750° C.; a second decarbonator operating at 600° C., and a third decarbonator operating at 500° C. or similar arrangement. It should be appreciated that each decarbonated gas stream exiting one of the decarbonators can be passed through a heat exchanger to reduce its temperature to the temperature appropriate for the next stage in the series, or for the final stage as desired for downstream purposes.

In a commercial process the captured carbon dioxide will be recovered so as to regenerate the sorbent for reuse in the carbonator. Recovery includes decarbonation and sequestration of the carbon dioxide. Sequestration involves storing the recovered carbon dioxide in an underground cave or storage facility or storing the recovered carbon dioxide in pressurized vessels for commerical use. The decarbonation process is conducted in any suitable reactor, such as a fixed bed or fluidized bed calcinator, constructed from materials capable of withstanding the high temperature of the decarbonation conditions. A fluidized bed reactor is preferred, especially when the decarbonation step is coupled with a carbonation step.

Generally, the partially or fully loaded solid sorbent having carbon dioxide incorporated therein as calcium carbonate is decarbonated at a temperature greater than about 850° C., preferably, greater than about 880° C. Decarbonation is typically conducted at a temperature less than about 1,400° C., preferably, less than about about 1,100° C. The flow rate of the sorbent comprising calcium carbonate through the calcinator (decarbonator) can vary as known to the person skilled in the art. The calcinator is preferably fired with a mixture of fuel, such as methane, natural gas, or coal, and an oxidant, suitably air or oxygen, under combustion conditions. The gaseous stream exiting the calcinator comprises from about 95 to about 99 percent carbon dioxide, by volume; and for purposes of this invention is therefore deemed to be “enriched” in carbon dioxide. The material balance of the gaseous stream exiting the calcinator primarily consists of water and nitrogen.

FIG. 1 illustrates a reversible calcium looping process in a dual fluidized bed reactor system 10 adapated to utilizing the carbon dioxide sorbent composition of this invention. A carbon dioxide-containing gaseous stream 1 is fed into the first fluidized bed reactor 2 (carbonator), wherein the stream is contacted with the sorbent comprising calcium oxide, calcium aluminate, and the mixed metal oxide characterized by a perovskite crystalline structure, at a temperature greater than about 500° C. and less than about 750° C. A mixed phase stream 4 (gas/solid) exits carbonator 2 and is transferred to separator 5, from which a decarbonated gaseous stream 16 is recovered. Also recovered from carbonator 2 is solid stream 6/7, a solid mixture comprising calcium carbonate. Solid stream 7 feeds into second fluidized bed 3 (calcinator or decarbonator), whereas solid stream 6 provides a stream for downstream disposal or utilization. Second fluidized bed 3 receives the solid calcium carbonate stream 7, fuel 8 (e.g., coal), and oxidant 9, such as air or oxygen, such that the calcium carbonate is calcined at a temperature ranging from greater than about 850° C. to less than about 1,400° C., so as to regenerate the sorbent composition of this invention. A mixed phase stream 11 (gas/solid) exiting calcinator 3 is fed into second separator 12. The regenerated sorbent exits separator 12 via stream 14 and is recycled to the carbonator 2. A portion of regenerated solid sorbent can be recycled from second separator 12 to decarbonator 3 via line 15. Also exiting second separator 12 is a carbon dioxide-enriched gaseous stream 13 comprising from about 95 to 99 volume percent CO₂, which is directed to a downstream sequestration unit or utilization method.

The solid sorbent composition of this invention can be cycled through greater than about 40 carbonation and decarbonation cycles with little degradation. Essentially no morphological changes are observed when a sample of the solid sorbent composition of this invention is analyzed by scanning electron microscopy (SEM) after at least 40 carbonation/decarbonation cycles, as compared with an SEM observation of a fresh as—synthesized sample of the composition.

### EMBODIMENTS

### EXAMPLE 1

An embodiment of the solid sorbent composition of this invention was synthesized comprising calcium oxide, calcium aluminate, and lanthanum aluminate. The starting materials for the synthesis were acquired from Sigma-Aldrich and included: hydrated lime Ca(OH)₂, aluminum hydroxide Al(OH)₃, and hydrated lanthanum nitrate.

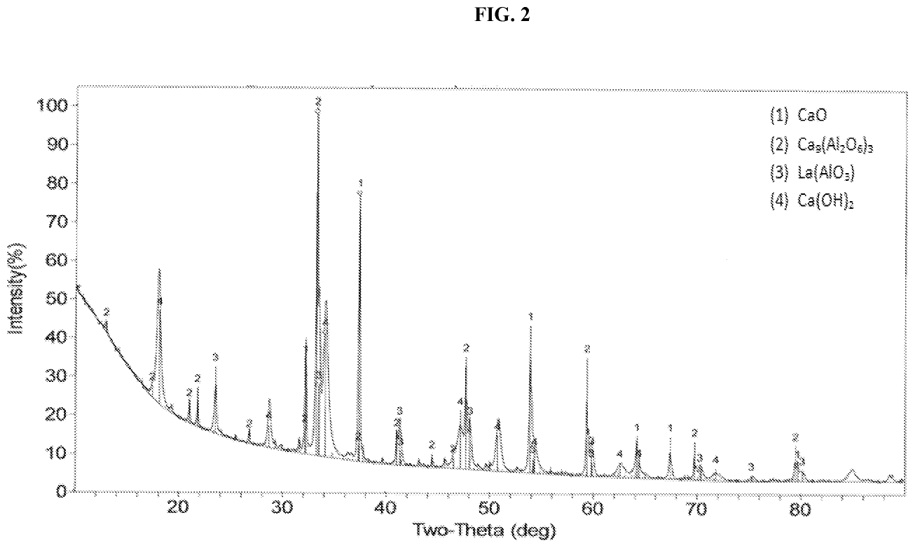

Hydrated lime (307.0 g), aluminum hydroxide (65.0 g), and hydrated lanthanum nitrate (68.5 g) were mixed with deionized water to form a slurry containing 20 percent solids by weight (excluding milling media). The slurry was milled at 60 RPM for 8 h in the presence of cylindrical ceramic milling media. The milling was conducted under air at room temperature and ambient pressure. Afterwards, the slurry was decanted to separate the milling media; and then the slurry was dried on a hot plate to evaporate the water. The resulting dried material was calcined under air at 1,100° C. for 3 h to yield a sample of the solid sorbent composition of this invention comprising 49.6 percent lime (CaO), 16.4 percent portlandite (Ca(OH)₂), 28.2 percent crystalline nonacalcium tris(dialuminate) of formula Ca₉(Al₂O₆)₃, and 5.8 percent lanthanum aluminate (LaAlO₃), as determined by XRD analysis (Panalytical X′pert diffractometer using Cu radiation). FIG. 2 presents the XRD pattern of the as-synthesized sample.

### EXAMPLE 2

The sorbent composition of Example 1 (50 g) was loaded into a quartz reactor in a fixed-bed configuration and placed in a tubular furnace. Then, the sorbent was subjected to a series of carbonation-decarbonation cycles under varying process conditions. With reference to Table 1, carbonation cycles were performed at 650° C. under a stream comprising 15 volume percent carbon dioxide in air for cycles #11-13 and 15 volume percent carbon dioxide in nitrogen for all other cycles. Cycles noted as “wet” were run with the gas stream bubbled through deionized water at 21° C. and pH 7 prior to introduction into the reactor. Calcination cycles were conducted at 950° C. under air for cycles #11-13 and under nitrogen for all other cycles. Samples were weighed before and after the calcination cycle. The weight gain of the sorbent was recorded with the results shown in Table 1.

TABLE 1
Sorbent of Example 1 under Carbonation-Decarbonation Cycles¹

| | % of Theoretical | Sorbent Capacity, | |
|---|---|---|---|
| Cycle | Max Capacity | g CO₂/g sorbent | Notes |
| 1 | 56.6 | 0.30 | |
| 2 | 58.0 | 0.31 | |
| 3 | 52.8 | 0.28 | |
| 4 | 52.5 | 0.28 | |
| 5 | 52.5 | 0.28 | |
| 6 | 60.1 | 0.32 | |
| 7 | 60.4 | 0.32 | |
| 8 | 58.0 | 0.31 | |
| 9 | 56.6 | 0.30 | |
| 10 | 56.3 | 0.30 | |
| 11 | 59.8 | 0.32 | |
| 12 | 57.0 | 0.30 | |
| 13 | 56.6 | 0.30 | |
| 14 | 54.6 | 0.29 | |
| 15 | 53.9 | 0.28 | |
| 17 | 66.3 | 0.35 | In presence of water vapor |
| 18 | 67.0 | 0.36 | |
| 19 | 61.0 | 0.32 | |
| 20 | 64.2 | 0.34 | |
| 21 | 62.4 | 0.33 | |
| 22 | 76.7 | 0.41 | In presence of water vapor |
| 27 | 75.6 | 0.40 | In presence of water vapor |
| 28 | 76.7 | 0.41 | |
| 33 | 74.2 | 0.39 | In presence of water vapor |
| 34 | 71.7 | 0.38 | |
| 39 | 76.7 | 0.41 | In presence of water vapor |
| 40 | 91.7 | 0.49 | Sorbent re-milled |
| 41 | 88.8 | 0.47 | Pure CO₂ |
| 42 | 85.6 | 0.46 | |

¹Breaks in numbering refer to cycles run through carbonation-decarbonation cycle(s), but not measured.

From Table 1 it is seen that the CO₂ sorption capacity of the composition of this invention increased over the duration of the cycles. Increased capacity was noted in carbonation cycles made in the presence of water vapour; and significantly the increased sorbent capacity was maintained after the water vapour was removed. Overall the composition of this invention provided a carbon dioxide capture capacity of more than 0.31g CO₂/g sorbent (7 moles CO₂/kg sorbent) over multiple carbonation-decarbonation cycles. Following hydration, the sorbent capacity increased to 0.35 g CO₂/g sorbent (8 moles CO₂/kg sorbent) in cycle 17 and again to 0.41 g CO₂/g sorbent (9 moles CO₂/kg sorbent) at cycle 22.

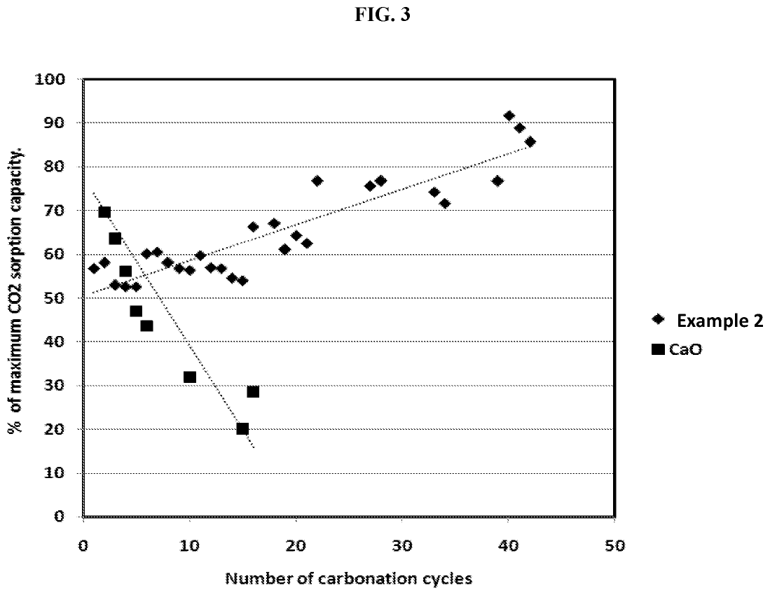

FIG. 3 presents a graph plotting percent of theoretical maximum carbon dioxide sorption capacity for the composition of Example 1 as determined for the above-described carbonation-decarbonation cycles.

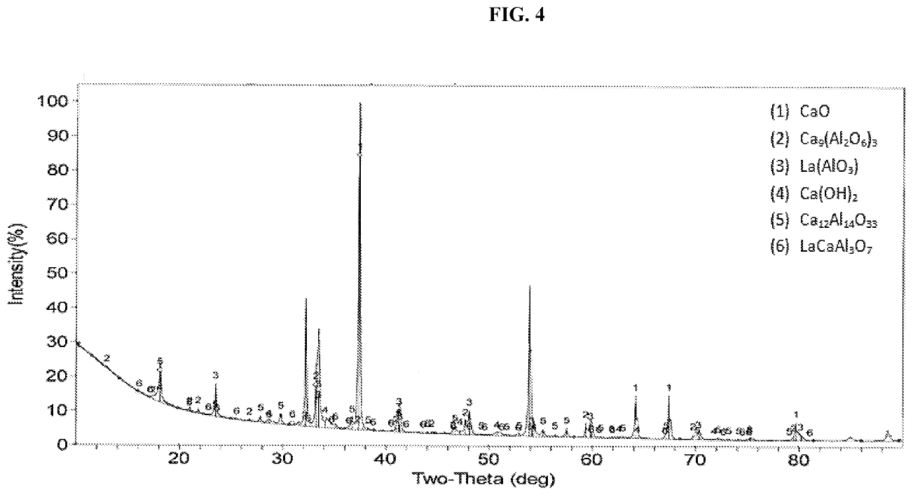

FIG. 4 presents an XRD pattern of the solid sorbent composition of Example 1 after cycling through 15 carbonation-decarbonation cycles per Example 2, ending on a decarbonation cycle. The XRD pattern identified the presence of portlandite (Ca(OH)₂), lime (CaO), nonacalcium tris(dialuminate) Ca₉(Al₂O₆)₃, mayenite Caₗ₂Al₁₄O₃₃, and lanthanum aluminate (LaAlO₃).

The composition of the invention was imaged using scanning electron microscopy (SEM) first as freshly synthesized in accordance with Example 1 and again after 15 carbonation-decarbonation cycles as obtained per Example 2. The sample that was put through the cycles showed no significant change in morphology as compared with the fresh as-synthesized sample.

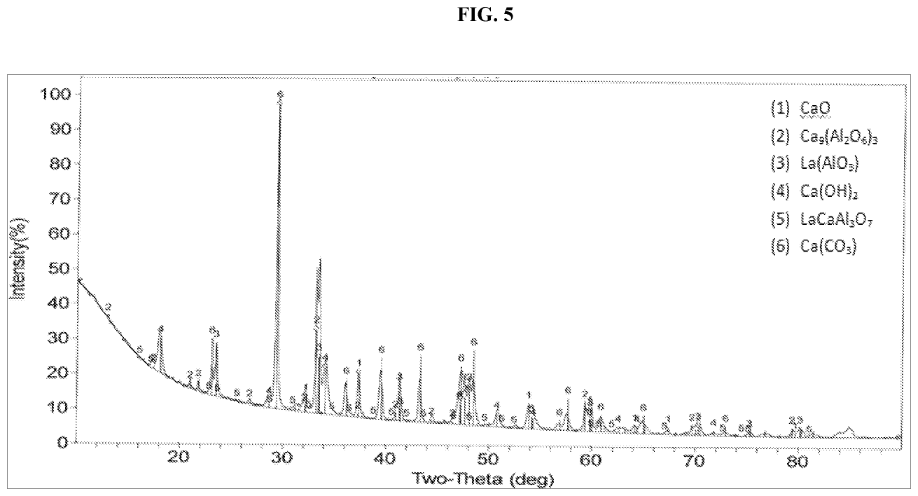

FIG. 5 presents an XRD pattern of the solid sorbent composition of Example 1 after cycling through 42 carbonation and decarbonation cycles per Example 2, ending on a carbonation cycle. The XRD pattern identified the presence of lime (CaO), portlandite (Ca(OH)₂), calcite (CaCO₃), nonacalcium tris(dialuminate) (Ca₉(Al₂O₆)₃), and lanthanum aluminate (LaAlO₃).

### COMPARATIVE EXPERIMENT 1

For comparative purposes a series of carbonation-decarbonation experiments was run using calcium oxide as the sorbent. A fixed bed reactor similar to the one used in Example 2 was packed with calcium oxide. Carbonation cycles were conducted at 650° C. under a stream comprising 15 volume percent carbon dioxide in nitrogen. Cycle #20 noted as “wet” was run with the gas stream bubbled through deionized water at 21° C. and pH 7 prior to introduction into the reactor. Calcination cycles were conducted at 950° C. under air for cycles #11-13 and under nitrogen for all of other cycles. The carbonation experiments were stopped when the sorbent capacity of the CaO dropped to less than 20 percent of the initial value measured in cycle #1.

Table 2 illustrates CO₂ sorbent capacity over 21 carbonation cycles for calcium oxide.Where the cycle is not reported in the table, no weighing was made.

TABLE 2
CaO Carbonation/Decarbonation Cycles¹

| | % of Theoretical | Sorbent Capacity, | |
|---|---|---|---|
| Cycle | Max Capacity | g CO₂/g sorbent | Notes |
| Start | 100.0 | 0.78 | |
| 1 | 69.5 | 0.54 | |
| 2 | 63.3 | 0.49 | |
| 3 | 56.0 | 0.44 | |
| 4 | 47.0 | 0.36 | |
| 5 | 43.6 | 0.34 | |
| 10 | 31.9 | 0.25 | |
| 15 | 19.9 | 0.15 | |
| 16 | 28.5 | 0.22 | In presence of water |
| | | | vapor |
| 21 | 19.2 | 0.15 | |

¹Breaks in numbering refer to cycles run through carbonation-decarbonation cycle(s), but not measured.

From Table 2 it is seen that the sorbent capacity of CaO continously dropped with or without the presence of water. FIG. 3 presents a graph plotting percent of theoretical maximum carbon dioxide sorption capacity for calcium oxide tested in this experiment, as compared with the sorbent of the invention illustrated in Example 2.

When Example 2 was compared with Comparative Experiment 1, it was seen that the solid sorbent composition of this invention provided a higher level of CO₂ uptake over a greater number of carbonation-decarbonation cycles, as compared with using calcium oxide alone as the sorbent.

### COMPARATIVE EXPERIMENT 2

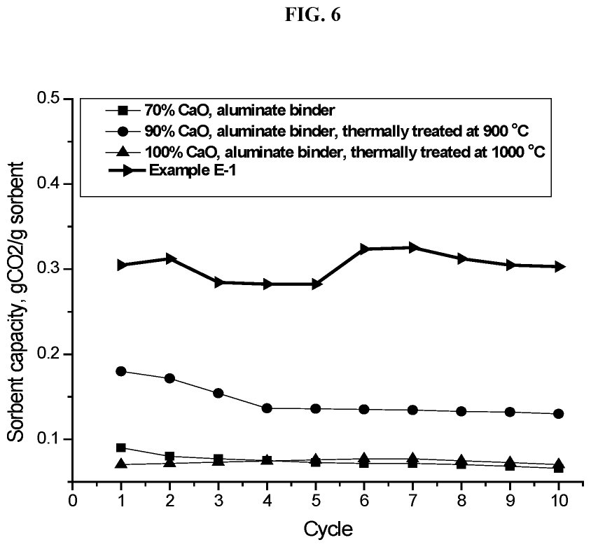

FIG. 6 presents a graph of carbon dioxide capture over 10 carbonation-decarbonation cycles for the solid sorbent composition of this invention, as prepared and tested in Examples 1 and 2 hereinabove. These data are compared with carbon dioxide capture over a similar number of cycles for calcium oxide-aluminate sorbents disclosed in the prior art (S. Wu, et al., Ind. Eng. Chem. Res., 49, 2010, 12269). The prior art sorbents, in particular, did not include a mixed metal oxide characterized by a perovskite crystalline structure, such as, lanthanum aluminate. The composition of the invention was prepared by calcination at 1,100° C., which is somewhat higher than the calcination temperature of the prior art; but the different calcination temperatures both result in formation of calcium oxide.

It was found that the solid sorbent of this invention comprising calcium oxide, calcium aluminate, and lanthanum aluminate provided a higher sorbent capacity, as compared to prior art sorbents consisting of calcium oxide and alumina binder.

### EXAMPLE 3

The composition of Example 1, comprising 49.6 percent lime (CaO), 16.4 percent portlandite (Ca(OH)₂), 28.2 percent crystalline nonacalcium tris(dialuminate) of formula Ca₉(Al₂O₆)₃, and 5.8 percent lanthanum aluminate (LaAlO₃) by weight, was mixed with an alumina binder. The resulting solid mixture comprised 90 percent composition of Example 1 and 10 percent alumina binder by weight. Sufficient water was added to form a paste that was aged at room temperature for 24 hours. Then, the paste was extruded through an opening of 0.1 inch diameter (2.5 mm) and cut into extrudate pellets ranging from 0.2 to 0.3 inch (5.1-7.6 mm) in length. The pellets were dried in air for 1 hour, then treated in a CO₂ atmosphere (100 vol. %) by heating to 100° C. at a rate of 1°/min; then held at 100° C. for 1 hour, then heated to 1,000° C. at a rate of 5°/min, then held at 1,000° C. for 1 hour. The pellets were thereafter heat treated at 900° C. under nitrogen (100 vol. %) for 3 hours to completely desorb adsorbed CO₂ yielding a composition of this invention (1.826 g).

The composition thusly prepared was exposed to alternating carbonation and decarbonation cycles as follows: first under a flow of nitrogen (199 standard cubic meters per minute (SCCM)) mixed with carbon dioxide (1 SCCM) for 3 hours to determine the adsorption capacity for CO₂ at 100° C., 200° C., and 400° C.; and second under a flow of nitrogen (199 SCCM) alone at 900° C. for 3 hours to desorb CO₂. Samples were weighed before and after each decarbonation cycle to give the sorbent capacities shown in Table 3.

TABLE 3
CO₂ Adsorption Capacity of Example 3

| | | CO₂ Captured |
|---|---|---|
| | | Within 1 Hour |
| Temperature | Exposure | (g CO₂/g sorbent) |
| 100° C. | 0.5 vol. % CO₂ | 0.067 |
| | in N₂ | |
| 200° C. | 0.5 vol. % CO₂ | 0.062 |
| | in N₂ | |
| 400° C. | 0.5 vol. % CO₂ | 0.120 |
| | in N₂ | |

The results in Table 3 show that the composition of this invention is effective in removing carbon dioxide from a gaseous stream containing only 0.5 volume percent CO₂.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention.

Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A solid sorbent composition comprising calcium oxide, calcium aluminate, and a mixed metal oxide characterized by a perovskite crystalline structure.

2. The sorbent composition of claim 1 comprising from greater than about 30 percent to less than about 90 percent by weight calcium oxide (dried basis), based on the total weight of the composition.

3. The sorbent composition of claim 1 comprising from greater than about 5 percent to less than about 50 percent by weight calcium aluminate, based on the total weight of the composition.

4. The sorbent composition of claim 1 comprising from greater than about 2 percent to less than about 20 percent by weight mixed metal oxide characterized by a perovskite crystalline structure, based on the total weight of the compostion.

5. The sorbent composition of claim 1 wherein the calcium aluminate is selected from crystalline structures of molecular formula Ca₉(Al₂O₆)₃ , CaAL₄O₇, CaAl₂O₄, and Ca₁₂Al₁₄O₃₂Y, wherein Y is selected from the group consisting of O²⁻, N²⁻, (OH⁻)₂, (F⁻)₂, (Cl⁻)₂, (H₂O)₄(Cl⁻)₂, (H₂O)₄(F⁻)₂, and (e⁻)₂ where e⁻ represents a free electron, and mixtures of the aforementioned crystalline structures.

6. The sorbent composition of claim 1 wherein the calcium aluminate comprises a mixture of Ca₉(Al₂O₆)₃ and Ca₁₂Al₁₄O₃₃.

7. The sorbent composition of claim 1 wherein the perovskite crystalline structure is represented by formula ABX₃, wherein A is a divalent cation of Group IIA; B is a tetravalent cation of Group IVA; and X represents divalent oxide.

8. The sorbent composition of claim 7 wherein A is barium, strontium, or a mixture thereof; and B is titanium.

9. The sorbent composition of claim 1 wherein the perovskite crystalline structure is represented by formula ABX₃, wherein A is selected from trivalent cations of Group IIIA and lanthanide rare earths; B is a trivalent cation of Group TIM, and X represents divalent oxide.

10. The sorbent composition of claim 9 wherein A is selected from lanthanum, yttrium, scandium, gadolinium, ytterbium, and mixtures thereof ; and B is aluminum.

11. The sorbent composition of claim 1 wherein the mixed metal oxide characterized by a perovskite structure is selected from lanthanum aluminate, barium titanate, strontium titanate, and mixtures thereof.

12. A method of synthesizing a solid sorbent composition capable of reversibly capturing carbon dioxide from a carbon dioxide-containing gaseous stream, comprising:
(a) preparing a slurry comprising a liquid diluent, calcium oxide or a precursor thereof, calcium aluminate or a precursor thereof, and a mixed metal oxide having a perovskite crystalline structure or a precurser thereof;
(b) milling the slurry;
(c) drying the slurry to remove the liquid diluent; and
(d) calcining the resulting dried material under calcination conditions sufficient to produce the solid sorbent capable of reversibly capturing carbon dioxide, the solid sorbent comprising calcium oxide, calcium aluminate, and the mixed metal oxide having the perovskite crystalline structure.

13. The method of claim 12 wherein the precursor to calcium oxide is calcium hydroxide, calcium carbonate, calcium nitrate, or a mixture thereof.

14. The method of claim 12 wherein the precursor to calcium aluminate is a mixture comprising calcium oxide (anhyrous or hydrated) and alumina, or hydrotalcite of molecular formula CaAl₂(CO₃)₂(OH)₄. 3H₂O, or hydrocalumite of molecular formula Ca₄Al₂(OH)₁₂ (Cl, OH)₂.4H₂O or formula Ca₄Al₂(OH)₁₂ (CO₃).4H₂O, or any mixture of the aforementioned materials.

15. The method of claim 12 wherein the precursor to the mixed metal oxide having the perovskite structure is selected from corresponding mixed metal nitrates, sulfates, halides, hydroxides, and mixtures thereof.

16. The method of claim 12 wherein the slurry contains from 10 to 50 percent solids and comprises a liquid diluent selected from water, C₁₋₄ alcohols, and mixtures thereof.

17. The method of claim 12 wherein calcination is conducted under air or oxygen at a temperature greater than 800° C. but less than 1,400° C.
